(19) United States
(12) Patent Application Publication
(10) Pub. No.: US 2008/0000143 A1
(43) Pub. Date: Jan. 3, 2008

(54) Fishing lures

(75) Inventor: William McBurney, Shell Beach, CA (US)

Correspondence Address: Stephen E Feldman, 7th FL, 12 E 41st Street, New York, NY, 10017, US

(73) Assignee: MacDaddy's Fishing Lures, Inc.

(21) Appl. No.: 11/484,151

(22) Filed: Jul. 3, 2006

(51) Int. Cl. A01K 85/00; A01K 85/01

(52) U.S. Cl. 43/42.32; 43/42.34; 43/42.5

(57) ABSTRACT

A highly reflective fishing lure for use in fresh and salt water, and used to catch fish. The fishing lure includes a body molded from a precious metal and multiple stones being set onto the body. These stones form particular designs on the body. The lure has a tempered, gold plated fish hook. These lures when used in the water cause reflections from sunlight that makes the lures glimmer, sparkle and glisten and a refraction of light that makes light bounce in all directions thereby resulting in the attraction and catching of fish. These fish lures double as jewelry pieces.

### TECHNICAL FIELD

The present disclosure relates to fishing lures. More particularly, the present disclosure relates to fishing lures that enhance the light that reflects and refracts from the fishing lures themselves.

### BACKGROUND OF RELATED ART

Fish have been a food source since they came into existence and since then man has invented numerous and ingenious ways to catch these fish.

Fishing lures have been made in all different fashions. Most lures are made to resemble small fish because this is believed to attract larger fish. Some lures are made to have translucent features or are colorful. Plastic beads may be attached to the lures using glue or other adhesives to hold the beads in place.

But still, to this day, it is not always easy to catch fish. Man is still looking for new and better ways to catch fish. Therefore, there is still a continuing need for inventing fishing lures that have visually enhancing characteristics that reflect and refract light thereby enticing fish.

### SUMMARY OF THE INVENTION

A highly reflective fishing lure for use in fresh and salt water. The fishing lure is used to catch fish and can be used as jewelry.

The lure includes a body being molded from a precious metal (e.g. gold, silver, platinum, etc,.). This metal does not peel or chip and is very durable.

The lure also includes a plurality of stones being set onto the body. The stones may be either precious or semi-precious stones such as rubies, diamonds, sapphires, citrine, topaz, garnet, aqua marine, cubic zirconia, ect. and combinations thereof. These stones are set in any fashion but the most common setting is done with a pave setting or a bezel setting. Once set, these gems can form any design on the lure body.

Each lure body has at least one through hole located on the body. The through hole is usually located on a top portion of the body. The through hole is used for receiving a fishing line or a necklace depending on the situation in which the lure is used.

Also the lure may include a tempered hook. The tempered hook is gold plated with 14k gold. The tempering being performed after the gold is adhered or fused to the hook. The hook is either a single hook or a triple hook.

This fishing lure entices fish when in water because the reflection from the lure body makes the lure glimmer, sparkle and glisten and the refraction of light from the stones makes light bounce in all directions. To a fish, this combination is an irresistible treat.

In a first embodiment, the fishing lure has an oblong body whereby the body is about 2 to 4 inches long and about 1 to 3 inches wide. In a second embodiment, the fishing lure has long and narrow body and the body and the hook have a decorative fly pattern attached thereto.

Each lure may be used for fishing, as a key chain or as a necklace charm. The lures may also be engraved or may include a printed logo on a front thereof.

A method for making a fishing lure is: fusing 14k gold to a fish hook; tempering the fish hook; attaching a lure body to the fish hook, said body being molded from a precious metal; and setting stones onto the lure body in a particular design.

When a lure made by the above method is constructed the body of the lure will reflection sunlight making the lure glimmer, sparkle and glisten and the stones will refract light making the light bounce in all directions.

An additional step used in the above method is attaching a fly design to the lure body and fish hook further enticing the fish.

The invention, together with attendant advantages, will be best understood by reference to the following detailed description of the invention when used in conjunction with the figures below.

### BRIEF DESCRIPTION OF THE DRAWINGS

Preferred embodiments of the presently disclosed gemstone arrangement are described herein with reference to the drawings, wherein:

FIG. 1 is a forward facing view of the first embodiment of the present invention;

FIG. 2a is a side view of a fishing hook used in the first embodiment of the present invention;

FIG. 2b is a side view of a connection ring used in the first embodiment of the present invention;

FIG. 2c is forward facing view of a lure body of the present invention;

FIG. 3 is a forward facing view of a second embodiment of the present invention;

FIG. 4 is a forward facing view of a third embodiment of the present invention;

FIG. 5 is a forward facing view of a fourth embodiment of the present invention

FIG. 6a is a hook of a fifth embodiment of the present invention;

FIG. 6b is the hook and a body of the fifth embodiment of the present invention;

FIG. 6c is the hook, body and a fly design of the fifth embodiment of the present invention;

FIG. 7 is a side view of a sixth embodiment of the present invention;

FIG. 8 is a side view of a seventh embodiment of the present invention;

FIG. 9 is an alternate usage for all embodiments of the present invention; and

FIG. 10. is an alternate usage for all embodiments of the present invention.

### DETAILED DESCRIPTION OF THE EMBODIMENTS

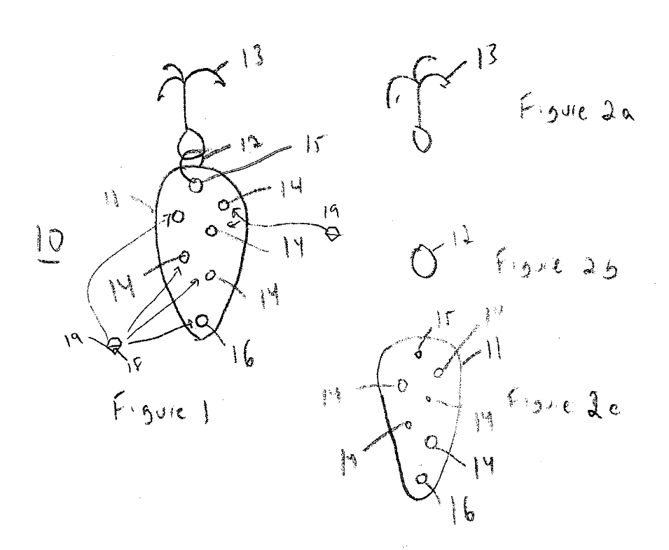

Referring now in specific detail to the drawings in which like referenced numerals identify similar or identical elements throughout the several views, and initially to FIG. 1, a novel fishing lure 10 is shown.

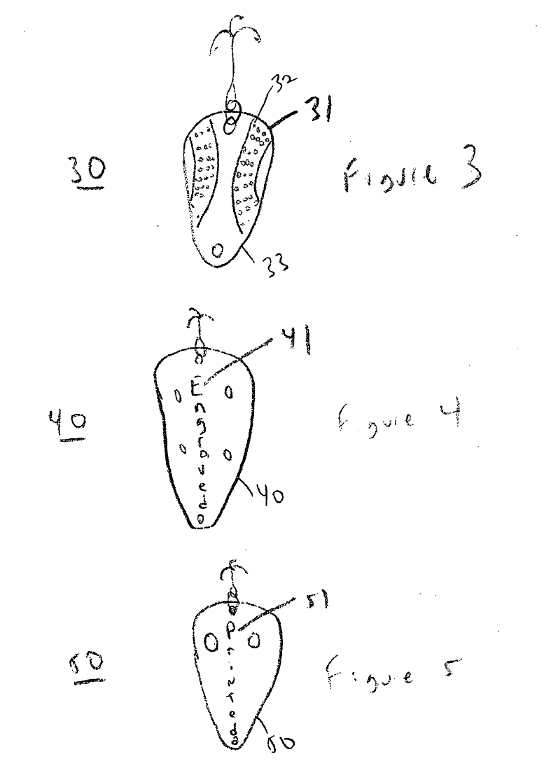

FIGS. 1-2c show a preferred embodiment of the present invention. In this embodiment, the fishing lure 10 has a spoon-shaped body 11 that is connected to a fishing hook 13 via a connecting ring 12. The fishing lure 10 is highly reflective and can be used in fresh or salt water for catching fish. These lures 10 can also double as an attractive piece of jewelry or be mounted on a wall.

The fishing lure 10 has a body 11 that is molded from a precious metal. The most common metals that are used are gold and silver but any precious metal that has reflective properties can be used without changing the scope of the invention. The metal must be durable and not chip or peel when exposed to water.

The body 11 is shaped similar to the head of a spoon. This shape is used because when in use the arcuate surfaces of the body 11 will cause the body 11 to vigorously move from side to side adding to the reflective properties of the body 11. The body 11 is typically about 2 to 4 inches long and about 1 to 3 inches wide and is oblong. The weight of the lure body will vary (usually between about 0.5 to 4 ozs.) depending on the conditions in which the lure 10 will be used.

The body 11 also contains opening 14 in the front face of the body 11. These opening 14 are for receiving gemstones 19. The stones 19 maybe either precious or semi-precious stones, such as but not limited to rubies, diamonds, sapphires, citrine, topaz, garnet, aqua marine, cubic zirconia, or combinations thereof.

The gemstones 19 may be either set with a bezel setting wherein the gems are placed in the opening 14 and the sides of the openings 14 are crimped over a girdle 18 of the gemstones 19 or the gemstones 19 may be placed in the setting and the lure body 11 heated and cooled so the gemstones 19 are secured in place.

Another setting commonly used is a pave setting 31. This setting 31, as shown in FIG. 3, allows small gemstones 32 to be laid on the body 33 when the body 33 is a semi-molten state. These gemstones 32 form a unique deign on the surface of the body 33.

FIG. 1 also shows on the body 11 a through hole 15. This through hole 15 is located on a top portion of the body 11. This through hole 15 is for the placement of a fishing line (not shown) in the body 15.

As shown in FIGS. 9 and 10 the through holes 92 and 103 respectively may also be used for receiving a chain 91 such as necklace or a key ring 101. The key ring 101 also holding a key 102.

In the first embodiment of FIG. 1, another through hole 16 is located on the bottom of the lure body 11. This through hole 16 receives a connecting ring 12 as shown in FIG. 2b. Attached to the connecting ring 12 is a tempered hook 13. This tempered hook 13 is plated with 14k gold but other metals may be used. Once the gold is plated or fused to the hook 13 using any plating method, the hook 13 is tempered giving the hook added durability. In this embodiment a triple-end hook 13 is used but any hook commonly used for fishing may be utilized.

The fishing lure 10 of the above embodiment, when placed in the water, lets the body 11 reflect sunlight making the lure 10 glimmer, sparkle and glisten and the stones 19 refract light making the light bounce in all directions To a fish, these reflective properties are enticing, giving a fisherman an advantage of attracting and hopefully catching lots of fish.

FIG. 4 shows another embodiment of the present invention in which the lure body 40 includes all the features of the first embodiment but is also engraved 41 with a particular sentimental design.

FIG. 5 is a lure body 50 also having all the advantages of the first embodiment but also including a printed logo 51 on the forward facing side.

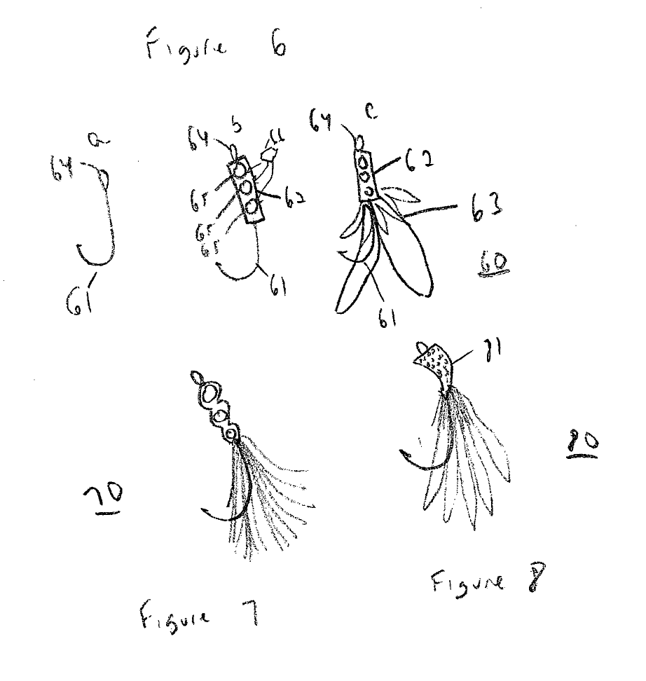

A method for making a fishing lure of the present invention is shown in FIGS. 6a-c. In this embodiment, a fishing hook 61 is fused with 14k gold. The gold-plated fishing hook 61 is then tempered by any commonly used tempering method.

The hook 61 also includes a through hole 64 at a top portion. This through hole 64 is for the placement of a fishing line (not shown) in the body 61. The through hole may also be used for receiving a chain or a key ring similar to that found in FIGS. 9 and 10.

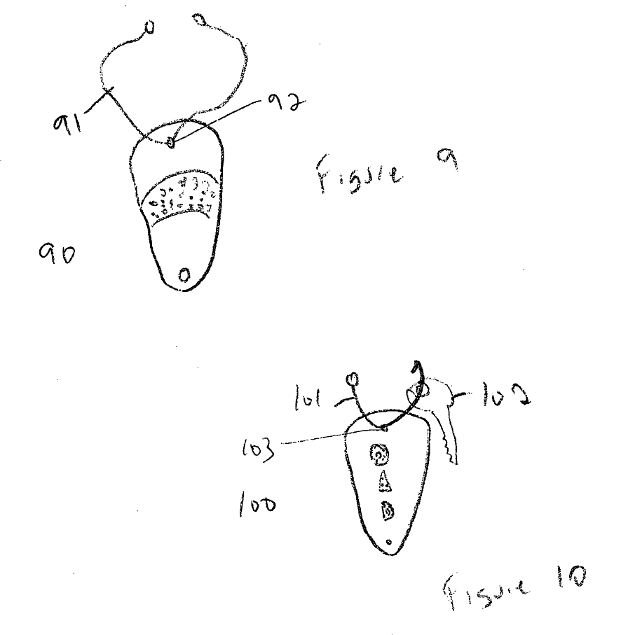

A lure body 62 is then attached to the fishing hook 61. The lure body 62 may be crimped to the hook 61 or the hook 61 may be placed in a mold (not shown) and the precious metal being molded around the hook 61. This lure body 62 is molded from a precious metal, such as gold or silver. The lure body in this embodiment has a cubic shape but any shape may be used. For example in FIG. 7, the body 71 is somewhat circular in design. The lure body 62, in the preferred embodiment, is about one inch long and k inch wide.

Gemstones 66 are then set onto the lure body 62. In the preferred embodiment, a bezel setting 65 is used but as shown in FIG. 8, a pave setting 81 may also be used (discussed above).

A fly design 63 is then attached to the lure body 62 and the fish hook 61. The attachment is made with a fishing tackle specifically used for by experienced fly fishermen.

The fishing lure 60 of the above embodiment, when placed in the water, lets the body 62 reflect sunlight making the lure glimmer, sparkle and glisten and the stones 66 refract light making the light bounce in all directions. To a fish, these reflective properties are enticing, giving a fisherman an advantage of attracting and hopefully catching lots of fish.

Although the illustrative embodiments of the present disclosure have been described herein with reference to the accompanying drawings, it is to be understood that the disclosure is not limited to those precise embodiments, and that various other changes and modifications may be affected therein by one skilled in the art without departing from the scope or spirit of the disclosure. All such changes and modifications are intended to be included within the scope of the disclosure.

What is claimed is:

1. A highly reflective fishing lure for use in fresh and salt water, said fishing lure being used to catch fish and as jewelry comprising:
a body, said body being molded from a precious metal;
a plurality of stones being set onto the body, said stones forming a design;
at least one through hole being located on the body, said through hole located on a top portion of said body;
a tempered hook, said tempered hook being plated with gold,
whereby, when the lure is placed in the water, the body reflects sunlight making the lure glimmer, sparkle and glisten and the stones refract light making the light bounce in all directions.

2. The fishing lure as claimed in claim 1 whereby said body is molded from one of gold and silver.

3. The fishing lure as claimed in claim 1 whereby said body is oblong.

4. The fishing lure as claimed in claim 1 whereby said body is long and narrow.

5. The fishing lure as claimed in claim 1 whereby said body is about 2 to 4 inches long and about 1 to 3 inches wide.

6. The fishing lure as claimed in claim 1 whereby said stones are one of precious and semi-precious stones.

7. The fishing lure as claimed in claim 1 whereby said stones are from a group which includes rubies, diamonds, sapphires, citrine, topaz, garnet, aqua marine, cubic zirconia, and combinations thereof.

8. The fishing lure as claimed in claim 1 whereby the stones are pave set.

9. The fishing lure as claimed in claim 1 whereby the stones are bezel set.

10. The fishing lure as claimed in claim 1 whereby said through hole is for connecting a fishing line to said body.

11. The fishing lure as claimed in claim 1 whereby said hook is a single hook.

12. The fishing lure as claimed in claim 1 whereby said hook is a triple hook.

13. The fishing lure as claimed in claim 1 whereby said body and said hook have a decorative fly pattern attached to thereto.

14. The fishing lure as claimed in claim 1 whereby said plated gold is 14k gold.

15. The fishing lure as claimed in claim 1 whereby the lure body is durable and does not chip or peel.

16. The fishing lure as claimed in claim 1 whereby each hook is tempered after the gold is plated to the hook.

17. The fishing lure as claimed in claim 1 whereby the lure may be used as a key chain.

18. The fishing lure as claimed in claim 1 whereby the lure may be used as a necklace charm.

19. The fishing lure as claimed in claim 1 whereby said body is engraved.

20. The fishing lure as claimed in claim 1 whereby said body includes a printed logo on a front thereof.

21. A method for making a fishing lure, comprising the steps of:
fusing 14k gold to a fish hook;
tempering said fish hook;
attaching a lure body to said fish hook, said body being molded from a precious metal; and
setting stones onto said lure body,
whereby, when the lure is used in water, the body reflects sunlight making the lure glimmer, sparkle and glisten and the stones refract light making the light bounce in all directions.

22. The method as claimed in claim 21 further comprising the step of:
attaching a fly design to said lure body and said fish hook.

23. The method as claimed in claim 22 whereby the stones are pave set.

24. The method as claimed in claim 22 whereby the stones are bezel set.
